(19) United States
(12) Patent Application Publication
(10) Pub. No.: US 2023/0410478 A1
(43) Pub. Date: Dec. 21, 2023

(54) LABEL-DEPENDENT LOSS FUNCTION FOR DISCRETE ORDERED REGRESSION MODEL

(71) Applicant: CANON U.S.A., INC., MELVILLE, NY (US)

(72) Inventor: Xiwu Cao, Arcadia, CA (US)

(21) Appl. No.: 18/035,635

(22) PCT Filed: Nov. 8, 2021
(86) PCT No.: PCT/US2021/058457

§ 371 Date: May 5, 2023

Related U.S. Application Data
(60) Provisional application No. 63/111,409, filed on Nov. 9, 2020.

(51) Int. Cl. G06V 10/766; G06V 10/776; G06V 10/764

(52) U.S. Cl. CPC G06V 10/766; G06V 10/776; G06V 10/764

(57) ABSTRACT

A processing apparatus is provided that is configured to perform operations including obtaining a plurality of images having been evaluated by different sources such that each source has classified each of the plurality of image as being a member of one of a predefined class, generating a distribution array identifying a number of times each image of the plurality of images has been classified into each of the predefined classes, generating, for each predefined class, a loss function based on the ratio of a number of images in other classes of the predefined classes to a number of images to this predefined classes, providing the generated loss function for each predefined class as evaluation parameters to a model, and using the generated loss function to determine that the model classifies raw image data as being a member of one of the predefined classes according to a predetermined accuracy threshold.

### CROSS-REFERENCE TO RELATED APPLICATIONS

This application claims the benefit of priority from U.S. Provisional Patent Application Ser. No. 63/111,409 filed on Nov. 9, 2020, the entirety of which is incorporated herein by reference.

### BACKGROUND

### Field

The present disclosure relates to an improvement in an image processing method.

### Description of Related Art

In machine learning, loss function is used to measure the performance of a model, which allows us to tune the parameter or weight coefficients for a model to achieve the optimized performance on some given data. The selection of a loss function determines if we could build an effective model. There are many established loss functions available, including Mean Square Error (MSE), Mean Absolute Error (MAE), Smooth Mean Absolute Error (SMAE), Log-Cosh Loss (LCL), Quantitle Loss (QL), Hinge loss (HL), and Cross Entropy.

Generally, if a problem can be treated as a regression, we use MSE, MAE, LCL, or QL as its loss function; otherwise, we take Hinge loss or cross entropy if it is a classification problem. Discrete ordered regression is an intermediate problem between regression and classification. To tackle it, we often treat it as either a standard regression problem or a standard classification problem.

Treating the discrete ordered regression as a standard multi-class classification problem will lose the ordering information of each class. Some approaches tried introduce the ordering information by generalizing the loss function from binary classification with multi thresholds, but it might not be able to give a full picture of model performance easily.

Treating the discrete ordered regression as a standard regression problem requires us to map the ordinal classes into some real numeric values. This mapping may not be good enough to allow us to use the loss functions in standard regression, like mean squared error or mean absolute error, since those loss functions require the variances of the fitting errors from the model do not vary across different sample classes.

### SUMMARY

In one embodiment, a processing apparatus is provided that includes comprising one or more memories storing instructions and one or more processors that, upon executing the stored instructions; are configured to perform operations including obtaining a plurality of images having been evaluated by different sources such that each source has classified each of the plurality of image as being a member of one of a predefined class, generating a distribution array identifying a number of times each image of the plurality of images has been classified into each of the predefined classes, generating, for each predefined class, a loss function based on the ratio of a number of images in other classes of the predefined classes to a number of images to this predefined classes, providing the generated loss function for each predefined class as evaluation parameters to a model, and using the generated loss function to determine that the model classifies raw image data as being a member of one of the predefined classes according to a predetermined accuracy threshold.

In one embodiment, the obtained plurality of images include a plurality of labeled image sets wherein, each image set of the plurality of image sets includes common images, each of the plurality of images in each image set is labeled as being in a particular class selected from a predefined set of classes, each image set has been labeled by an evaluator, and each image could be labeled differently by a different evaluator.

In another embodiment, the processing apparatus performs operations including generating likelihood sets of images corresponding to each of the predefined classes wherein each likelihood set includes all images in the particular class as being classified from the different sources.

In other embodiments, the predefined classes represent a degree characterizing an image feature. In other embodiments, the predefined classes hold some uncertainty due to human perception. In a further embodiment, the predefined class is sharpness and each of the predefined classes represent a different degree of image sharpness by human perception. In further embodiments, each of the predefined classes represents a metric of human perception and the generated loss function makes the classified raw image data to match the human perception.

In another embodiment, the processing apparatus is further configured to perform operations including modifying at least one parameter of the model other than the generated loss function, and using the updated model with the generated loss function to determine whether the updated model classifies raw image data according to the predetermined accuracy threshold.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 is graphical classification matrix.

FIG. 2 is graphical representation of sharpness evaluation of a plurality of image data performed by a plurality of evaluators.

FIG. 3 is an exemplary image from the set of plurality of image data evaluated in FIG. 2.

FIG. 4 is a graphical depiction of differences in evaluation across classes by the evaluators.

FIG. 5 is a depiction of evaluations by the evaluators over different possible groups.

FIG. 6 is an normalized array of data values used in accordance with the present disclosure.

FIG. 7 is a graphical depiction of the loss function for each possible group.

FIG. 8 are predictions from other sharpness evaluation methods to illustrate the advantage of the loss functions for each possible group calculated according to the present disclosure.

FIG. 9 is a block diagram detailing the hardware components of an apparatus that executes the algorithm according to the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples.

The present disclosure provides an algorithm that advantageously obtains and adjusts a loss from data being processed to improve interpolation associated with the models performance by reducing the negative impact of inaccurate distance measurements and ensures that the model does not place too much weighting on the outliners in the data set. As such, an algorithm according to the present disclosure designs and generates individual loss functions for each class in a multiple class setting, the individual loss functions being based on the probability of real evaluation distribution by using the uncertainty in ground truth data.

Discrete ordered regression or ordinal regression is a type of regression for predicting an ordinal variable. It is not a standard regression problem since its prediction does not contain continuous numeric values, but instead only several discrete values. It is also not a standard classification problem because its prediction values, or labels, are ordered. Some examples of discrete ordered regression problems are predicting human preferences on a movie, level of customer satisfaction on the service received, or user ratings on a book. These preferences or ratings, for example, might go from 1 to 5 with 1 representing ‘very poor’ and 5 representing ‘very good’.

Mathematically, any classification problem or regression problem can be formulated as a minimization problem over a loss function over given data as shown in Equation (1)

L=Σᵢl(ƒ(xᵢ),y_{desired}) Equation (1)

where xᵢ is the given input data, ƒ is the predict function, y_{desired} is the ideal prediction, l is the loss function to evaluate the performance of the prediction from the task, and L is the total loss from our given data.

Since discrete ordered regression is an intermediate problem between regression and classification, there are two typical approaches to tackle it. One is to treat this intermediate problem between regression and classification is as unrelated multiclass classification problem and resolve this by applying hinge loss, cross entropy or other known loss functions in multiclass classification. Another way to treat this intermediate problem is to treat it as a standard regression problem and then take mean squared error (MSE) or mean absolute error (MAE) as the loss functions. However, neither of these approaches work well with discrete ordered regression.

Treating them as a standard classification problem does not work since it will lose the ordering information of each class in the framework of multi-class classification setting. One option is to generalize the loss function from binary classification by applying multi thresholds to multi classes to handle the inherent order in this multi-class classification problem.

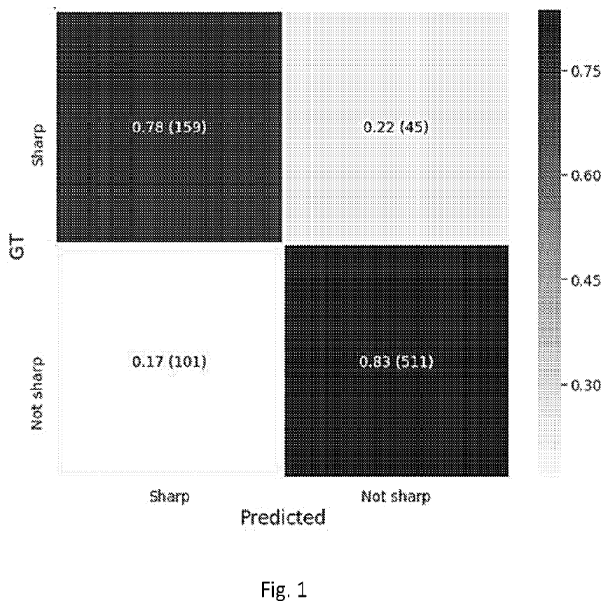

One example is shown in FIG. 1, which is the confusion matrix of a multi-class classification model by applying a threshold of 3. The data used here are based on prediction of image sharpness, where there were five classes going from 1 to 5 with 1 representing ‘very blurry’ and 5 representing ‘very sharp’. To evaluate the performance of the model, we applied a threshold of 3 to group the data into two categories, sharp and not sharp, and the original problem in a multi-class classification setting is then converted into a binary classification. We are thus able to calculate the precision, recall, accuracy or any other metrics from binary classification, to evaluate how well the model performs its sharpness prediction on the given data.

Although this approach provides some insight on the performance of the model, it does not provide a full evaluation picture of model performance, since, in its essence, it only partially evaluates the model performance in a specific condition where the data was split into two groups at a specific threshold. To know more about the model, we at least have to apply multiple different thresholds. However, even if that was done, the result might still end up with multiple partial shot of the evaluation instead of a full picture, which is incapable of serving as a good evaluation metric for searching the best model parameter.

Treating discrete ordered regression as a standard regression problem does not work either. Although it is capable of utilizing the order information between classes, but the common loss functions in regression, like MSE, MAE, do not work here since they require that the variances of the fitting errors do not vary across different sample classes. However, this requirement is hard to achieve, because it is usually impossible to map the ordinal class values to the real numeric value in a way that allows them to be able to tell the true distance between classes. Furthermore, even if it were done, there is no way to guarantee the variances of fitting errors across classes remain the same.

The present disclosure advantageously provides a novel approach to build our customized loss function that does not suffer from the assumption requirement by a standard regression while providing a full evaluation picture of the model performance without the need to make multiple partial evaluations.

According to an embodiment that will be used to illustrate the advantages, the prediction of the sharpness of a set of 150 images is used to illustrate the structure of a loss function. This approach advantageously utilizes the uncertainty in our ground truth data.

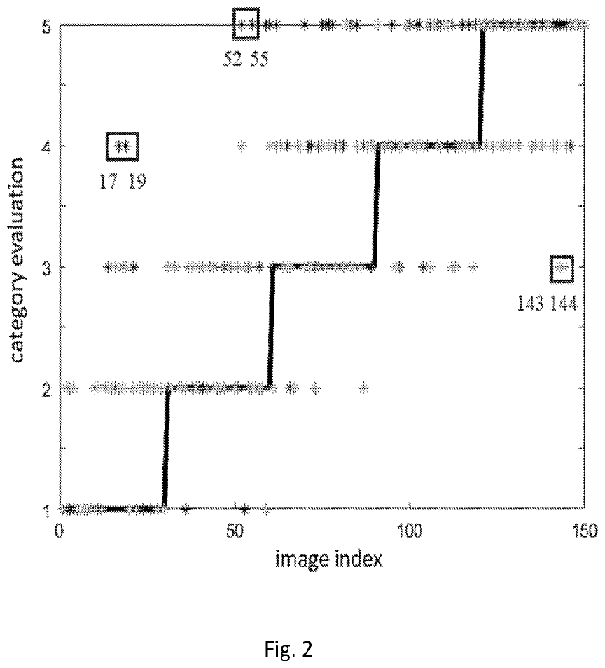

FIG. 2 shows the raw ground truth data of sharpness evaluation from three persons over 150 selected images. Here three persons were asked to evaluate the sharpness of these images and group them into 5 categories from 1 to 5 with 1 representing ‘very blurry’ and 5 representing ‘very sharp’. Their evaluation results are sorted based on the results of one selected person, which is marked in black thick line. The other two persons' evaluations are marked respectively in stars. As we can observe, different persons have completely different perceptions on the sharpness of the same image.

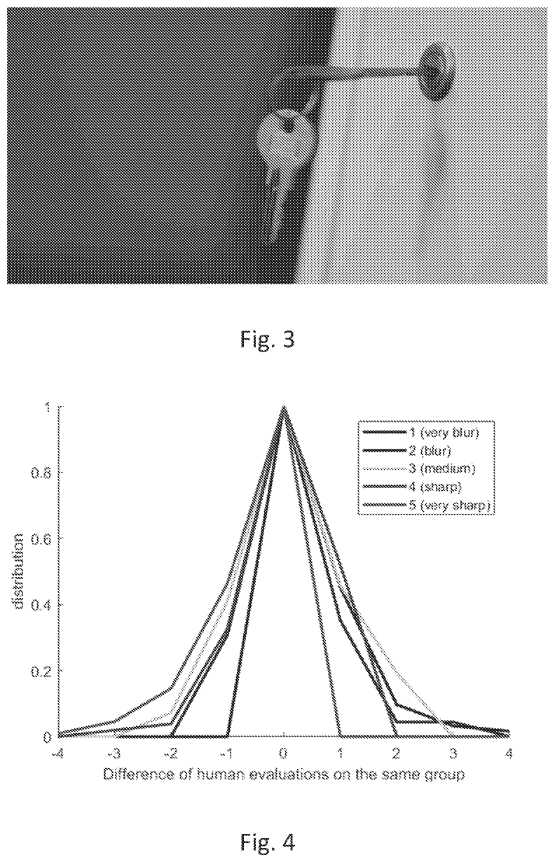

One example is shown in FIG. 3. It is also the image 17 marked in the rectangles in FIG. 2. The first person (black) gives a score of 1 (very blur), but the second person (dark stars) and third person (light stars) give scores of 2 and 4, respectively. We know 4 stands for sharp which is totally different from the perception of first person.

Six images that are marked in FIG. 2 with the scores from three persons are rearranged in Table 1 to show the uncertainty of human perception on the evaluation of image sharpness.

TABLE 1
Sharpness evaluation of six selected images from three persons

| Image index | Person 1 | Person 2 | Person 3 |
|---|---|---|---|
| 17 | 1 | 2 | 4 |
| 19 | 1 | 3 | 4 |
| 52 | 2 | 4 | 5 |
| 55 | 2 | 2 | 5 |
| 143 | 5 | 5 | 3 |
| 144 | 5 | 5 | 3 |

Although different persons show different evaluations on the same image, they also demonstrate a large amount of consistence in their evaluations. This consistence can be verified by the cross-correlation coefficients between the evaluations of different persons, which is shown in Table 2

TABLE 2
Cross-correlation coefficients on the evaluations
of sharpness of 150 images from three persons

| | Cross correlation coefficient |
|---|---|
| person 1-person 2 | 0.815 |
| person 1-person 3 | 0.837 |
| person 2-person 3 | 0.793 |

The variance of human perception can further be examined from these three person's evaluation on each class and understand why we cannot use the common loss functions in standard regression. Before we examine the variance of evaluation on each class, the data is rearranged into five possible-groups. Let us use possible-group 1 as an example here. Possible-group 1 collects and includes all images in the data set that possibly belong to class 1. The data was collected as follows. For each image, if any one person gave a score of one, it is believed that there is some probability this image might belong to class 1. The differences of the evaluations between any one of the three persons (including this person himself) and this person are calculated. Note that the difference of the evaluation between a person and himself is zero. Similarly, we are able to collect data for other possible-groups. The distribution of the difference of human evaluations for each possible-group are plot in FIG. 4. We can then calculate the one standard variance of evaluations for each possible-group, shown in Table 3

TABLE 3
One standard deviation of human perception
differences over five possible-groups

| | One standard deviation (68%) |
|---|---|
| possible-group 1 | 0.93 |
| possible-group 2 | 0.84 |
| possible-group 3 | 0.95 |
| possible-group 4 | 0.79 |
| possible-group 5 | 0.98 |

As can be observed from Table 3, the variances for each possible-group are different. Furthermore, as shown in FIG. 4, we know that their distributions are also not symmetric. For example, possible-group 1 is more asymmetric to the right, and possible-group 5 is more asymmetric to the left. Both facts violate the assumption required from the loss functions in a standard regression, like MSE or MAE. As such, a novel way to calculate and determine the loss function is needed and described below.

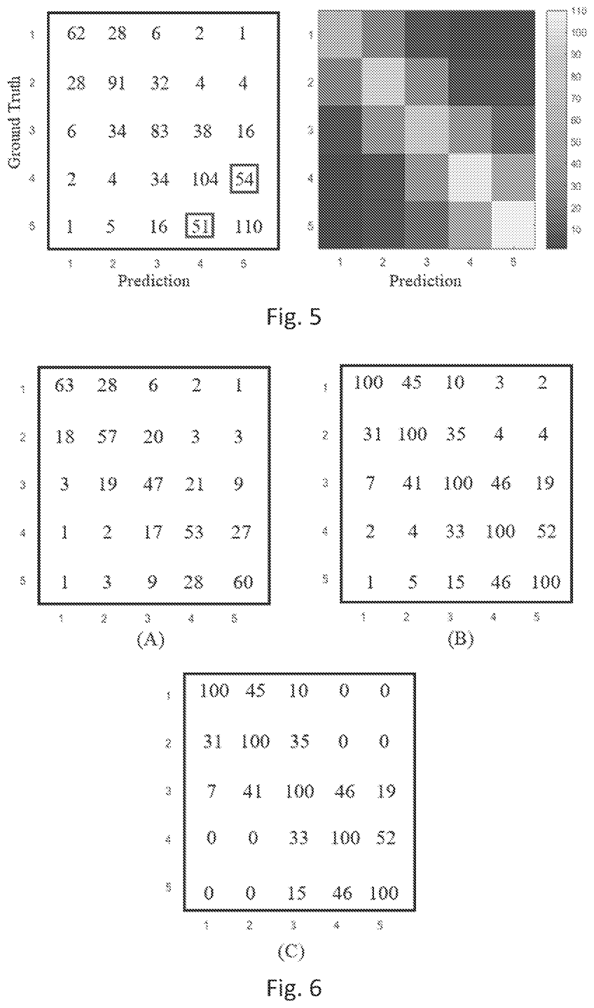

What follows is a description of the way the loss function according to the present disclosure is built. Following a similar procedure that we used in FIG. 4, raw data for each possible class is collected or obtained for each possible-group from an original set of data. In this example, the raw data is collected for each of those 150 images shown in FIG. 2. The raw data is plotted as shown in FIG. 5 which represents plots of the distribution of evaluation of image sharpness of the raw data that was collected over a predetermined number of possible groups. In this instance, the evaluations shown in FIG. 5 represent the distribution of human evaluation regarding image sharpness over five possible groups (or classes).

Each row in FIG. 5 represents one possible-group of images. As stated above, a possible-group of images is defined if any image is labeled with a score of that group by an evaluator. In other words, one image can be classified into multiple possible-groups. For example, the image 17 in FIG. 2 will be classified into possible-group1, possible-group2, and possible-group 4. Note that the number in the distribution array here does not represent the number of images but the number of times that a person gave a score of specific class. Thus, the array itself does not need to be symmetric. For example, 54 is marked in FIG. 5 and that indicates that means there are 54 times people gave a score of class 5 for possible-group 4 images, and on the contrary, there are only 51 times for people to give a score of class 4 for possible-group 5 images.

Once the distribution array is acquired, two normalization processes are applied to the data. The top left panel (A) in FIG. 6 is obtained by normalizing each row in FIG. 5 to make sure the sum of each row is 100. Some rows could sum up to 101 or 99 because of numeric issue. With this process, each normalized value tells the percentage of this evaluation on the possible-groups. Thereafter, each value is further divided by the desired evaluations that are located on the diagonal line of this distribution array with these results shown on the top right panel in FIG. 6. The value here represents the ratio of this evaluation to the desired evaluation. Finally, a threshold of 5 is applied to reset any value smaller than 5% in the normalized array to zero, which means if the ratio of all person's evaluations in this class to the desired class is smaller than 5%, it is likely due to the noise in the evaluation.

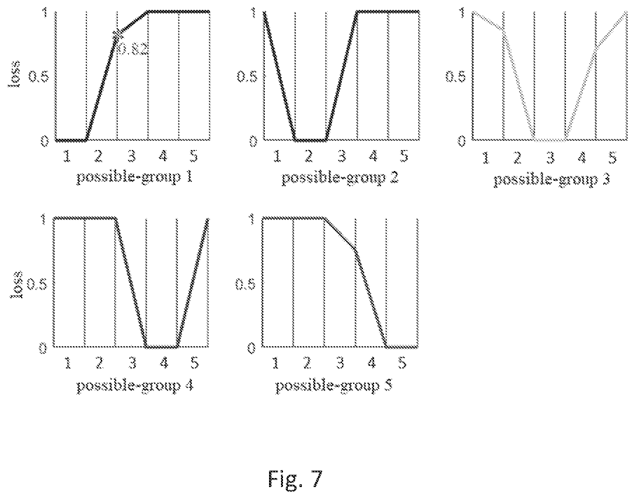

The data in the bottom panel in FIG. 6 is used to build the customized loss functions according to the present disclosure. A loss function is separately built for each possible-group. For example, a possible-group 1 (top left in FIG. 7) is an example to illustrate how the loss functions for each possible-group are obtained. For the possible-group 1, the distribution of human evaluations in five classes are 100, 45, 10, 0, and 0. The first number is 100, which means it is 100 percent possible to give a prediction of class 1 given the possible-group 1. The last two number are zeros, which means it is almost impossible for the prediction to be true if the possible-group is one but you have a prediction of class 4 or class 5. In other words, if we use the probability that your prediction is true to build our loss function, the prediction of class 1 for possible-group 1 should have no loss, but the prediction of class 4 or 5 should have a maximum loss 1.

To find the loss function of a prediction of class 2 or class 3, we use their ratio. In other words, if there are 55 times of predictions falling on class 2 or class 3, 45 of them are more likely located in class 2 and only 10 of them are located in class 3. Thus, we can use the ratio between 45 and 55 (45+10), which is 0.82, as the transition loss point we are looking for in splitting between class 2 and class 3.

Similarly, we can build the customized loss function for all other possible-groups, and all the loss functions for these five possible-groups are shown in FIG. 7. The final loss functions from these five possible-groups is the loss functions we will use for the five classes in the data. Note that the loss function built here is based on the probability that an evaluation is true, thus if we subtract the loss from 1 (100%), the value is directly proportional to the performance of the model on the given data.

The advantages of the loss function built according to the present disclosure which was built from sharpness predictions. Three different exemplary algorithms in sharpness prediction were applied to a set of 1000 selected images in order to evaluate the effectiveness. In one embodiment, the evaluation algorithms are device-specific algorithms implemented on different computing devices. For example, the three algorithms may include one from Android platform that used only the spatial features of an image, one from iOS platform that took only frequency features of an image, and one from a cloud-based service that combined both spatial and frequency features of an image.

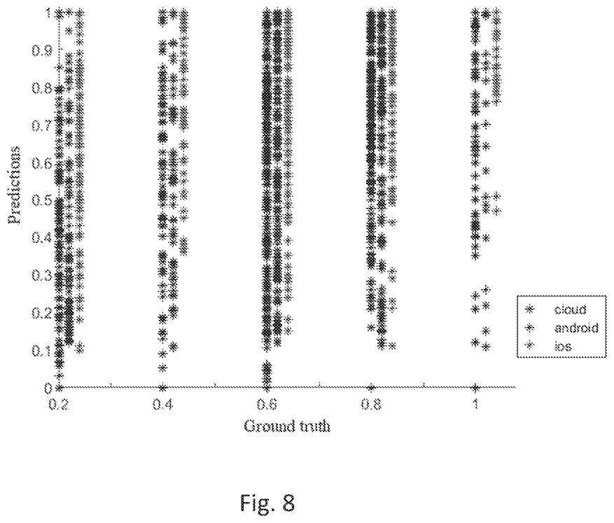

The raw predictions from three different sharpness prediction algorithms applied to a predetermined number or raw images (e.g. 1000 images) are shown in FIG. 8. The results were mapped the class labels 1 to 5 into a real value ranging from 0 to 1 by dividing by 5. To plot all the prediction from these three different algorithm, we also shifted the predictions from the Android and IOS visually to the right so they do not overlap. Four different metrics were selected, including cross-correlation coefficient (CC), mean squared error (MSE), mean absolute error (MAE), and our customized performance metric (CPM), to evaluate these three algorithm. These are merely exemplar and other evaluation algorithms may be used to evaluate the loss function and achieve the same advantageous results illustrated below. The results are shown in Table 4. Our customized performance metric is defined by subtracting the overall customized loss from 1.

TABLE 4
Evaluation of three sharpness prediction
algorithms using four different metrics

| | CC | MSE | MAE | CPM |
|---|---|---|---|---|
| Cloud | 0.29 | 0.32 | 0.27 | 0.35 |
| Android | 0.39 | 0.32 | 0.27 | 0.30 |
| IOS4 | 0.40 | 0.34 | 0.29 | 0.22 |

The performance of the algorithm in IOS was the worst; however, the CC did not reflect this human perception given that we actually obtained an even higher CC on IOS algorithm. For MSE and MAE, although they are able to tell the difference but the difference is quite small based on the number we obtained, our CPM worked successfully to show IOS algorithm is the worst of all three algorithms, which matches well the perception from humans.

As such, by generating the improved loss function, any of the parameters of the model can be changed in order to configure the model to yield a prediction with a predetermined accuracy level. This advantageously takes into account and improves the ability of a model to make better classifications with improved accuracy when the class in which objects are being classified is highly dependent on uncertain (e.g. subject) evaluations. This is particularly advantageous when the classification problem requires classification into a class that is impacted by human perception such as image quality, image sharpness, image noise and the like.

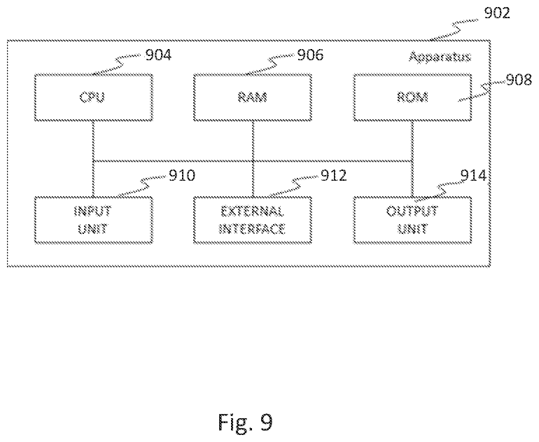

FIG. 9 illustrates the hardware of an apparatus that can be used in implementing the above described disclosure. The apparatus 902 includes a CPU 904, a RAM 906, a ROM 908, an input unit 910, an external interface 912, and an output unit 914. The CPU 904 controls the apparatus 902 by using a computer program (one or more series of stored instructions executable by the CPU) and data stored in the RAM 906 or ROM 908. Here, the apparatus may include one or more dedicated hardware or a graphics processing unit (GPU), which is different from the CPU 904, and the GPU or the dedicated hardware may perform a part of the processes by the CPU 904. As an example of the dedicated hardware, there are an application specific integrated circuit (ASIC), a field-programmable gate array (FPGA), and a digital signal processor (DSP), and the like. The RAM 906 temporarily stores the computer program or data read from the ROM 908, data supplied from outside via the external interface 912, and the like. The ROM 908 stores the computer program and data which do not need to be modified and which can control the base operation of the apparatus. The input unit 910 is composed of, for example, a joystick, a jog dial, a touch panel, a keyboard, a mouse, or the like, and receives user's operation, and inputs various instructions to the CPU 904. The external interface 912 communicates with external device such as PC, smartphone, camera and the like. The communication with the external devices may be performed by wire using a local area network (LAN) cable, a serial digital interface (SDI) cable, WIFI connection or the like, or may be performed wirelessly via an antenna. The output unit 814 is composed of, for example, a display unit such as a display and a sound output unit such as a speaker, and displays a graphical user interface (GUI) and outputs a guiding sound so that the user can operate the apparatus as needed.

According to the present disclosure, advantages of the custom generated loss function is provided by automatically obtaining and adjusting the loss function from the data which gives better interpretation about the model performance and reduces the negative impact associated with the inaccurate distance measurement in order to allow the model to not place too much weight on the outliers. The present disclosure achieves this advantage by designing individual loss functions for each class in a multiple class setting such that the loss function is based on the probability of real evaluation distribution and which uses the uncertainty in the ground-truth data.

The scope of the present invention includes a non-transitory computer-readable medium storing instructions that, when executed by one or more processors, cause the one or more processors to perform one or more embodiments of the invention described herein. Examples of a computer-readable medium include a hard disk, a floppy disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can also be supplied to the computer-readable storage medium by being downloaded via a network.

The use of the terms “a” and “an” and “the” and similar referents in the context of this disclosure describing one or more aspects of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter disclosed herein and does not pose a limitation on the scope of any invention derived from the disclosure unless otherwise claimed. No language in the specification should be construed as indicating any non-claimed element as essential.

It will be appreciated that the instant disclosure can be incorporated in the form of a variety of embodiments, only a few of which are disclosed herein. Variations of those embodiments may become apparent to those of ordinary skill in the art upon reading the foregoing description. Accordingly, this disclosure and any invention derived therefrom includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A method comprising
obtaining a plurality of images having been evaluated by different sources such that each source has classified each of the plurality of image as being a member of one of a predefined class;
generating a distribution array identifying a number of times each image of the plurality of images has been classified into each of the predefined classes;
generating, for each predefined class, a loss function based on the ratio of a number of images in other classes of the predefined classes to a number of images to this predefined classes;
providing the generated loss function for each predefined class as evaluation parameters to a model;
using the generated loss function to determine that the model classifies raw image data as being a member of one of the predefined classes according to a predetermined accuracy threshold.

2. The method according to claim 1, wherein obtaining a plurality of images includes
obtaining a plurality of labeled image sets wherein,
each image set of the plurality of image sets includes common images,
each of the plurality of images in each image set is labeled as being in a particular class selected from a predefined set of classes; and
each image set has been labeled by an evaluator; and
each image could be labeled differently by a different evaluator

3. The method according to claim 1, further comprising
generating likelihood sets of images corresponding to each of the predefined classes wherein each likelihood set includes all images in the particular class as being classified from the different sources.

4. The method according to claim 1, wherein the predefined classes represent a degree characterizing an image feature.

5. The method according to claim 1, wherein the predefined classes hold some uncertainty due to human perception.

6. The method according to claim 1, wherein the predefined class is sharpness

7. The method according to claim 1, wherein each of the predefined classes represent a different degree of image sharpness by human perception.

8. The method according to claim 1, wherein each of the predefined classes represents a metric of human perception and the generated loss function makes the classified raw image data to match the human perception.

9. The method according to claim 1, further comprising
modifying at least one parameter of the model other than the generated loss function; and
using the updated model with the generated loss function to determine whether the updated model classifies raw image data according to the predetermined accuracy threshold.

10. A processing apparatus comprising:
one or more memories storing instructions;
one or more processors that, upon executing the stored instructions; are configured to perform operations including
obtaining a plurality of images having been evaluated by different sources such that each source has classified each of the plurality of image as being a member of one of a predefined class;
generating a distribution array identifying a number of times each image of the plurality of images has been classified into each of the predefined classes;
generating, for each predefined class, a loss function based on the ratio of a number of images in other classes of the predefined classes to a number of images to this predefined classes;
providing the generated loss function for each predefined class as evaluation parameters to a model;
using the generated loss function to determine that the model classifies raw image data as being a member of one of the predefined classes according to a predetermined accuracy threshold.

11. The processing apparatus according claim 1, wherein the obtained plurality of images include a plurality of labeled image sets wherein,
each image set of the plurality of image sets includes common images,
each of the plurality of images in each image set is labeled as being in a particular class selected from a predefined set of classes; and
each image set has been labeled by an evaluator; and
each image could be labeled differently by a different evaluator.

12. The processing apparatus according to claim 10, wherein execution of the stored instructions further configures the one or more processors to perform operations including
generating likelihood sets of images corresponding to each of the predefined classes wherein each likelihood set includes all images in the particular class as being classified from the different sources.

13. The processing apparatus according to claim 10, wherein the predefined classes represent a degree characterizing an image feature.

14. The processing apparatus according to claim 10, wherein the predefined classes hold some uncertainty due to human perception.

15. The processing apparatus according to claim 10, wherein the predefined class is sharpness

16. The processing apparatus according to claim 10, wherein each of the predefined classes represent a different degree of image sharpness by human perception.

17. The processing apparatus according to claim 10, wherein each of the predefined classes represents a metric of human perception and the generated loss function makes the classified raw image data to match the human perception.

18. The processing apparatus according to claim 1, wherein execution of the stored instructions further configures the one or more processors to perform operations including
modifying at least one parameter of the model other than the generated loss function; and
using the updated model with the generated loss function to determine whether the updated model classifies raw image data according to the predetermined accuracy threshold.
